(19) United States
(12) Patent Application Publication
(10) Pub. No.: US 2006/0031928 A1
(43) Pub. Date: Feb. 9, 2006

(54) Detector and computerized method for determining an occurrence of tunneling activity

(76) Inventors: James Walter Conley, Herndon, VA (US); Eric B. Cole, Leesburg, VA (US)

Correspondence Address: MARTIN & HENSON, P.C., 9250 W 5TH AVENUE, SUITE 200, LAKEWOOD, CO, 80226, US

(21) Appl. No.: 10/915,686

(22) Filed: Aug. 9, 2004

(51) Int. Cl. G06F 15/16

(52) U.S. Cl. 726/11

(57) ABSTRACT

Devices and methods are provided to ascertain an existence of tunneling activity through a network firewall. According to one methodology, a set of norms is established for network traffic and a series of data packets transmitted through the firewall are monitored. Data packet attributes are analyzed to determine an absence or an existence of tunneling activity based on whether the attributes conform to the norms. A device is also provided in the form of a detector which is situated behind a network firewall and incorporates a data capture component for passively monitoring network traffic through the firewall and for producing detection data, and a data analysis component for comparing the detection data to a set of network traffic norms that are characteristic of an absence of tunneling activity. Tunneling activity potentially exists if the detection data fails to conform to any one of the set of norms.

### BACKGROUND OF THE INVENTION

The present invention generally relates to the field of network communications, and more particularly concerns the detection of tunneling activity through a network firewall.

Network firewalls operate at different layers of the protocol stack and use different criteria to restrict traffic. The lower in the protocol stack a packet is intercepted, the more secure the firewall. Most firewalls are configured to be permissive for internal systems, but very restrictive for systems outside the firewall. It is common practice to restrict inbound traffic from the Internet to only established connections. However, outbound traffic is often allowed from internal users on any port without restrictions. In a more restrictive environment, the firewall may only allow certain protocols to be used on outbound connections. For example, the firewall may only allow outbound HTTP for web browsing (port 80), POP3 for downloading email (port 110), and SMTP for sending email (port 25). This is a more secure strategy since it limits what internal users can do and is being implemented in more environments. The denied protocols are considered to be unsafe by the firewall administrator. An example of a denied protocol might be Instant Messaging (IM) traffic since an organization might view IM traffic as a security risk.

Firewalls typically fall into three broad categories: packet filters, application level gateways and stateful, multilayer inspection firewalls. Packet filtering firewalls work at the network level of the OSI model (or the IP layer of TCP/IP), and are usually part of a router firewall. This is the lowest layer at which a firewall can work. At this layer a firewall can determine whether a packet is from a trusted source, but cannot be concerned with what it contains or what other packets are associated with it. In a packet filtering firewall, each packet is compared to a set of criteria before being forwarded. This criteria can include source and destination IP addresses, source and destination port numbers, and protocol used. Depending on the packet and the criteria, the firewall can drop the packet, forward it, or send a message to the originator. The advantage of packet filtering firewalls is their low cost and low impact on network performance. Most routers support packet filtering. Even if other firewalls are used, implementing packet filtering at the router level affords an initial degree of security at a low network layer. This type of firewall only works at the network layer, however, and does not support sophisticated rule based models.

At the application level, firewalls know a great deal about what is going on and can be very selective in granting access. Application level gateways, also called proxy servers, are application specific and can filter packets at the application layer of the OSI model. Incoming or outgoing packets cannot access services for which there is no proxy. For example, an application level gateway that is configured to be a web proxy will not allow any ftp, gopher, telnet or other traffic through. Because proxy servers examine packets at the application layer, they can filter application specific commands. This cannot be accomplished with packet filtering firewalls since they know nothing about information at the application level. Application level gateways can also be used to log user activity and logins. While they do offer a high level of security, they can have a significant impact on network performance due to context switches which can slow down network access dramatically. They are also not transparent to end-users and require manual configuration of each client computer.

Stateful, multilayer inspection firewalls combine the aspects of these other types of firewalls. That is, they filter packets at the network layer, determine whether session packets are legitimate, and evaluate contents of packets at the application layer. They allow direct connection between client and host, alleviating the problem caused by the lack of transparency of application level gateways. They rely on algorithms to recognize and process application layer data instead of running application specific proxies. Stateful, multilayer inspection firewalls offer a high level of security, good performance and transparency to end-users. They are expensive, however, and due to their complexity are potentially less secure than simpler types of firewalls if not administered by competent personnel.

Normally a firewall is used to isolate an intranet from the Internet. A firewall can provide isolation or protection in two fundamental ways. Prior art FIGS. 1(a) & (b) diagrammatically illustrate these strategies, and it is not uncommon for a firewall to implement both of them at the same time. A first strategy shown in FIG. 1(a) is to limit the type of outbound connections a back end computer system 10, located behind the firewall 12, can make through the firewall to the Internet 14. Thus, improper outbound connection attempts such as represented by arrow 11 are rejected by the firewall 12, while proper outbound connection attempts such as represented by arrow 13 are permitted to pass through the firewall. A second strategy shown in FIG. 1(b) is more common and blocks initial connections 15 originating from a front end computer system 16, located exteriorly of the firewall 12, to the back end computer system 10. This typically only applies to connections to ‘non-server’ hosts. Servers, such as HTTP Web servers, must receive connections from the Internet. This is why such servers are preferably placed on a separate, more vulnerable portion of the network, usually called a de-militarized zone (DMZ).

Most Internet traffic is TCP based and involves the well-known 3-way handshake (SYN, followed by SYN ACK, followed by ACK) to establish any connection. An established connection is one in which the three way handshake has been completed. A half-open connection is considered one in which the first two legs of the three way handshake (SYN and SYN ACK) have been completed. A firewall can prevent the connection from establishing by rejecting the initial SYN packet. Since the only time a SYN packet will ever appear by itself is the first leg in the three-way handshake, this activity is easy to isolate. The activity of blocking SYN packets but allowing all other packets through is referred to as allowing only established connections. The firewall can, thus, pass all non-SYN packets since they pertain to previously established connections. Thus, the firewall need only keep track of the SYN packets, and can use the origin of the SYN packet to further protect or isolate the intranet. It is important to note that this activity of blocking SYN packets and blindly allowing all other packets is only done by a packet filtering firewall. A stateful or proxy based firewall will actually keep track of the state of a connection and only allow a packet through if it can be linked to an active connection.

Tunneling is one way to circumvent a firewall's protection. Tunneling refers to the transmission of data structured in one protocol within the format of another. In its simplest form, a firewall tunnel is a software implementation that connects a host behind a firewall (the back end host) to another host located exteriorly of the firewall (the front end host) in a manner that eludes the firewall's protection. The purpose of the tunnel is to provide the front end with access or services that would normally be blocked by the firewall. A tunneling protocol is one which encapsulates packets. It is used to transport multiple protocols over a common network, as well as provide the vehicle for encrypted virtual private networks (VPNs). It is said to “tunnel” because it “pushes through” packets of different types. A tunneling protocol is also referred to as an “encapsulation protocol,” which can be somewhat confusing since all protocols encapsulate. However, while a typical protocol encapsulates higher layer protocols within lower layer protocols, a tunneling protocol encapsulates a packet of the same or lower protocol.

A tunnel, thus, exists when traffic is encapsulated into a protocol that is allowed to freely traverse the perimeter defenses. In such a case, the firewall only sees the outermost protocol and not the encapsulated traffic. In this way, the encapsulated traffic has escaped scrutiny and may be a security risk. Prior art FIG. 2 diagrammatically illustrates the embedded nature of a tunnel. The traffic between the back end host 10 and the front end host 16 must be established on a port or protocol that is allowed by the firewall 12. This is the overt traffic 20. The front end server 16 can then convert the overt traffic 20 to perform some other function that would not be allowed through the firewall 12. This is the covert traffic 22.

When inbound connections are limited, tunnels can originate from the inside as shown in prior art FIG. 3(a). Here, the back end host 10 establishes a valid connection 30 through the firewall 12 to the Internet 14. The Internet user then tunnels back through the firewall 12 using covert traffic 32. Most tunnels are established when an internal host opens up an active TCP/IP connection through the firewall so that an external application can pass back through the firewall. This practice is very common with users wanting to access their office machine after hours from their home network. Their system on the corporate network cannot be directly reached from home, since the firewall will block these inbound connections. To circumvent this, before the employee leaves work he/she initiates a connection from the internal system on the corporate network to the home system and utilizes ‘keep alives’, which are packets sent out at regular intervals to simulate network traffic and maintain a connection. Gnutella is a program which implements this type of tunneling. The front end home system, thus, has an active connection to the back end office system.

When outbound connections are limited, tunnels must use a valid protocol for the outbound connection. As shown in prior art FIG. 3(b), the back end host 10 establishes an embedded connection 36 through the firewall 12 on the valid protocol 34. The denied protocol is then used inside the tunnel. ‘Loki’ and ‘Reverse WWW Shell’ are programs that implement the type of tunnel shown in FIG. 3(b). Loki is a client/server program published in the online publication Phrack. This program is a working proof-of-concept to demonstrate that data can be transmitted somewhat secretly across a network by hiding it in traffic that normally does not contain payloads. The code can tunnel the equivalent of a Unix RCMD/RSH session in either ICMP echo request (ping) packets or UDP traffic to the DNS port. This is used as a back door into a Unix system after root access has been compromised. Presence of LOKI on a system is evidence that the system has been previously compromised.

Reverse WWW Shell is a program which runs on an internal host and spawns a child every day at a given time. For the firewall, this child acts like a user, using his browser client to surf the Internet. In reality, this child executes a local shell and connects to the www server owned by a hacker on the Internet via a legitimate looking HTTP request and sends it a ready signal. The legitimate looking answer of the www server, owned by the hacker, are in reality the commands the child will execute on it's machine via the local shell.

There are no specific techniques known to the inventor for ascertaining the existence of tunneling activity through a firewall. However, given the inherent vulnerabilities attendant with circumventing firewalls, coupled with the apparent availability of tunneling software to accomplish the task, a need has arisen to provide a new approach to detecting tunneling activity in an effort to further protect networks from unauthorized infiltrations. The present invention is primarily directed to meeting this need.

### BRIEF SUMMARY OF THE INVENTION

The present invention thus provides a computerized method, and a device in the form of a detector, for determining whether tunneling activity is occurring through a network firewall. Preferably, both the method and the detector are capable of ascertaining an existence of tunneling activity between two network devices such as front end and back end computer systems which communicate by transmitting streams of data packets according to a communications protocol such as TCP/IP. Embodiments of the invention are described in the context of tunneling between a front end host and a back end host, sometimes also referred to as a front end computer system and a back end computer system, respectively. However, it is to be understood that these terms are not intended to be limiting since aspects of the invention can be applied to detection of tunneling between any suitable network devices. According to one embodiment of the computerized method, a set of norms is established for network traffic through the firewall, a series of data packets transmitted through the firewall is monitored, and attributes of the data packets are analyzed. Monitoring of the data packets may be accomplished with a network sniffer such as tcpdump. If the attributes conform to the set of norms a determination is made that there is an absence of tunneling activity. However, if the attributes fail to conform to the set of norms, a determination is made that tunneling activity potentially exists through the firewall.

The set of norms may include one or more expectations, namely: a first expectation that an average outbound packet length for selected communications protocols should not exceed a selected packet length value, preferably between about 1000 bytes and 1500 bytes, and more preferably 1250 bytes; a second expectation that a series of connections between the two computer systems should not exceed a selected time duration value, preferably between about 10 minutes and 30 minutes, and more preferably 20 minutes; a third expectation that a frequency of TCP connections (resulting from a TCP handshake) between the two computer systems should not exceed a selected connection frequency value, preferably about 200 connections per day; a fourth expectation that data corresponding to any one of a plurality of keywords (e.g., http, get, post, jpg, and smtp) should be absent in non-TCP packet transmission types; and a fifth expectation that encrypted data should be absent in particular communication's protocols, such as ICMP and UDP.

A second embodiment of the computerized method ascertains a potential existence of tunneling activity between a front end computer system located exteriorly of the network firewall and a back end computer system located behind the network firewall. The front end and back end computer systems are preferably adapted to communicate according to an overt communications protocol. According to this methodology, a set of parameters is established, with each parameter corresponding to a respective attribute of interest for network traffic transmitted through the firewall. A set of norms is also established, each being based on at least one of the parameters For example, one attribute of interest (i.e. parameter) may correspond to an average outbound packet length, with its corresponding norm being as preferred byte range as discussed above.

Network traffic is monitored through the firewall and data corresponding to the set of parameters is collected from each of a series of data packets associated with network traffic transmitted through the firewall. The term “series” in this context refers to a set of connections, or sessions, between two network devices. The particular timeframe for a series may be as short as a few seconds if dns is used as the tunnel, or as long as a day if the frequency of connections criteria above (i.e. 200 times per day),is being used. The network sniffer may capture, with respect to each connection between the front end and back end computer systems, various data corresponding to connection start time, connection end time, connection port, connection protocol, connection source IP address, connection designation IP address, and packet length, to name a few. If needed, derived data can then be generated from the observed data. The observed data and any derived data (collectively referred to as detection data) is then analyzed to determine whether it adheres to the set of norms. Potential tunneling activity is identified if it fails to conform to any one or more of them.

The detector of the present invention is adapted to be situated behind a network firewall and comprises a data capture component and a data analysis component. The data capture component passively monitors network traffic passing through the firewall and produces corresponding detection data. The data analysis component compares the detection data to a set of norms characteristic of an absence of tunneling activity and identifies potential tunneling if it fails to conform. The detection data produced by the data capture component preferably includes captured data from a network sniffer and any derived data generated from it. The data capture component preferably stores the detection data as a connection table in memory.

The tunnel detector may also comprise a response component for initiating at least one of a plurality of responses upon identifying a potential existence of tunneling activity. These responses can be any one or more of: a first response which entails transmission of a suitable notification to the network administrator; a second response which entails transmission of a suitable notification to the firewall for the purpose of terminating the tunneling activity; a third response entailing execution of a pre-defined script for the purpose of executing site specific response(s); and a fourth response which entails creation of a log containing data parameters for the tunneling activity.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIGS. 1(a) & 1(b) diagrammatically illustrate two prior art approaches by which a firewall can provide isolation to in intranet;

FIG. 2 diagrammatically illustrates the embedded nature of a tunnel;

FIG. 3(a) diagrammatically illustrates a prior art approach to infiltrating a firewall via tunneling when inbound connections are limited;

FIG. 3(b) diagrammatically illustrates a prior art approach to infiltrating a firewall via tunneling when outbound connections are limited;

FIG. 4 is a diagrammatic view of an exemplary embodiment of a detector according to the invention;

FIG. 5 represents a high level flowchart for computer software which implements the functions of the detector of the present invention;

FIG. 6 represents a high level flowchart for computer software which implements the functions of the detector's data capture component in FIG. 4;

FIG. 7 is a diagrammatic representation of the detector's logic engine;

FIG. 8 represents a high level flowchart for computer software which implements the functions of the detector's logic engine;

FIG. 9(a) is a diagrammatic representation of a pattern used by the detector's logic engine;

FIG. 9(b) shows how the patterns map as entries into the connection table; and

FIG. 10 is a diagrammatic representation of the detector's report module.

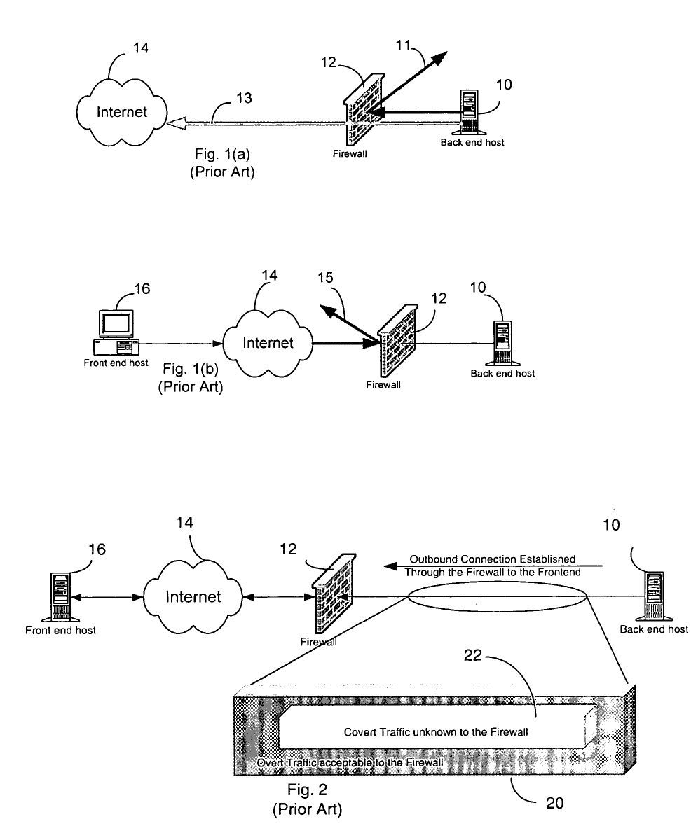

### DETAILED DESCRIPTION OF THE INVENTION

The establishment of tunnels through a firewall can be a major security risk. The present invention provides an approach to observing traffic passing through the firewall to determine if a tunnel exists. Captured data may be used to calculate information that is used by rules and patterns to identify the potential presence of a tunnel.

In the following detailed description, reference is made to the accompanying drawings which form a part hereof, and in which is shown by way of illustrations specific embodiments for practicing the invention. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

A diagrammatic view of a detector according to the present invention is shown in FIG. 4. Detector 40 passively monitors bi-directional TCP/IP traffic along the network segment 17 which passes through the firewall 12 to determine if a tunnel exists. Tunnel detector 40 is preferably situated just inside the firewall 12, for example in a demilitarized zone (DMZ), so that it is isolated from both back end systems on the local intranet 11 and the public Internet 14.

Certain representative characteristics of tunneling are of interest. One of these is whether an encapsulated protocol is detected within the overt traffic stream. The overt traffic stream can also be monitored for encryption. Encryption is expected in certain protocols, such as HTTPS and SSL; however other protocols do not normally have encrypted data. Traffic streams which normally have encrypted data can also be monitored to ascertain if the encryption implemented is consistent with the overt protocol.

Sets of communications, or series, between two hosts can be scrutinized to determine if the series has been established for an unusual period of time such that they are anomalous with other sessions of the same protocol. The series characteristics of many transactions on the Internet typically follow general pattern(s). Thus, when a series does not conform to that pattern, this may be evidence of a tunnel. In addition, the ports which are used for network traffic can be scrutinized. For example, since source ports on the client side of a transaction typically vary, repeated use of a port may be indicative of tunneling.

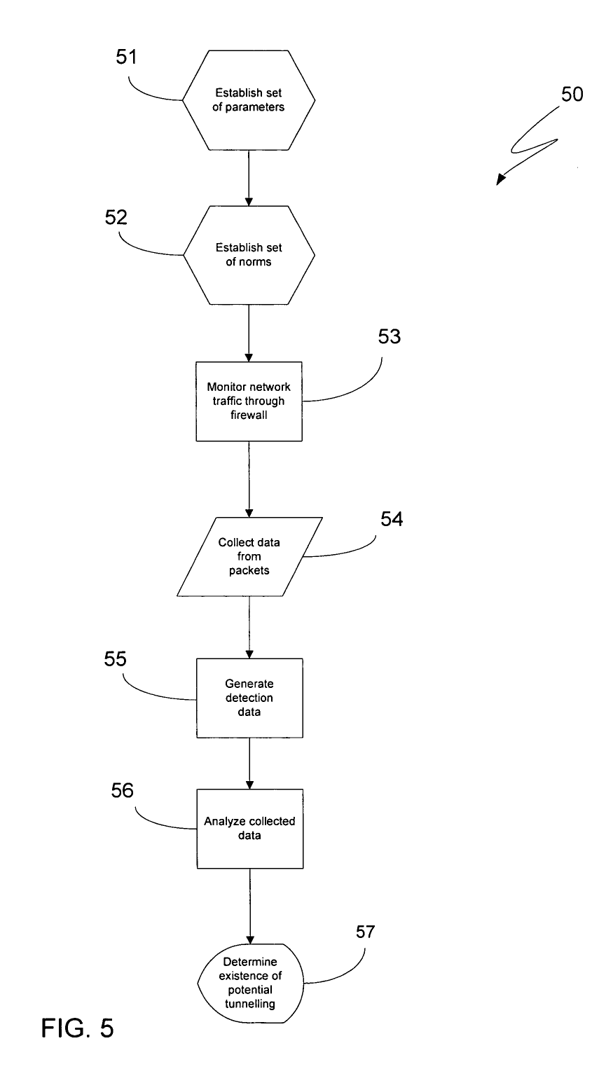

With these considerations in mind, FIG. 5 shows a high level flowchart for computer software implementing the functions of the tunnel detector of the present invention. The software programming could be developed for the Unix platform or others using a variety of available programming languages, such as Perl, with the software component(s) coded as subroutines, sub-systems, or objects depending on the language chosen. According to computerized method 50, a pre-defined set of parameters is established at 51 for the network traffic transmitted through the firewall, such as the bidirectional traffic appearing on network segment 17 in FIG. 4. Each of these parameters corresponds to a respective attribute of interest for the network traffic. Thus, for example, one attribute of interest might be the source IP address, another the designation IP address, protocol, port number, etc. At 52, a pre-defined set of norms is established, each being based on at least one of these parameters. Network traffic is monitored at 53, such as through a network sniffer, and data is captured at 54 corresponding to the pre-defined set of parameters. If needed, detection data is then generated from the captured data at 55 and analyzed at 56 to determine if it adheres to the pre-defined set of norms. A conclusion is then made at 57 as to whether potential tunneling activity exists based on adherence or non-adherence of the detection data to the set of norms.

As discussed above, the invention contemplates that network traffic through a firewall is expected to adhere to certain norms. Various rules can thus be established based on parameters or attributes of network traffic which, if satisfied, would correspond to a lack of adherence with a norm(s) and thus be indicative of tunneling. While the present invention describes the potential existence of tunneling activity to simply be non-adherence to one or more norms (i.e. the evaluation of a rule(s) as “True”), it is recognized that other various logic permutations can be established in order to arrive at the same conclusions on potential tunneling activity.

With reference again to FIG. 4, the tunnel detector 40 preferably comprises three primary components: a data capture component in the form of a capture module 42, a data analysis component in the form of a logic engine 44, and a response component in the form of a report module 46. The capture module monitors the traffic passing through the firewall, preferably by sniffing the Ethernet line through a program such as tcpdump. By doing so, it is able to read all IP packets passing by. The capture module will then store certain observed values, and calculate other derived values.

The capture module will search packet information for certain values and store this captured data as a connection table in memory. The capture module will also calculate derived values based on the observed traffic. For example, the establishment of a connection will be observed. The capture module will then keep track of the number of open connections. The capture module will look for connections and derive a series. A “connection” refers to a TCP/IP connection that begins with a completed handshake and ends when the connection is dropped or timed out. A “series” refers to a set of connections between two IP addresses. The beginning and end of a series is subjective. Also, since the definition of what constitutes a series vary from protocol to protocol, a configuration file can be established to contain values used to determine what connections are grouped into a series.

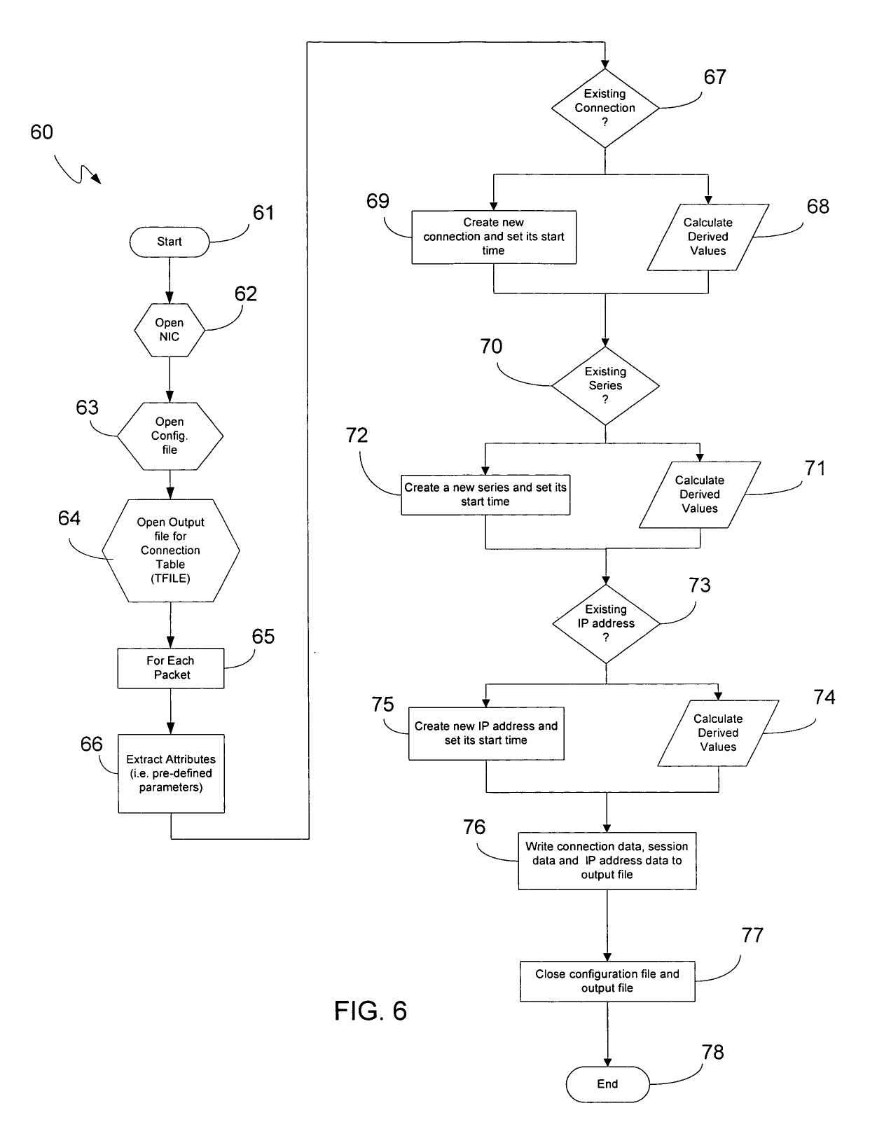

FIG. 6 shows a flowchart 60 for computer software which implements the functionality of the capture module 42. Following start 61, the network interface card (NIC) is opened at 62, preferably in promiscuous mode. The configuration file is opened at 63, as well as an output file 64 to contain the connection table (referred to as “TFILE”). For each packet at 65 passing through the firewall, various attributes are extracted at 66 corresponding to the pre-defined set parameters. If the captured data corresponds to an existing connection at 67, then derived values may be calculated at 68. Otherwise, information corresponding to the new connection is created at 69 and the start time of the new connection is set. If the extracted attributes correspond to an existing series at 70 then associated derived values can be calculated at 71. Otherwise, data corresponding to a new series is created at 72 and its start time is set. Finally, if the extracted attributes correspond to an existing IP address at 73 then associated derived values are calculated at 74. Otherwise, information corresponding to the new IP address is created at 75 and its start time is set. The associated connection data, session data and IP address data is then written to the output file at 76, after which both of the configuration file and the output file are closed at 77. The process then ends at 78.

The left column in Table I below represents various categories of interest whose corresponding data values can be stored as a connection table in memory:

TABLE I

| Item | Description |
|---|---|
| Connection Start Time | Observed - The time a new |
| | connection is observed by the |
| | Tunnel Detector. |
| Connection Duration | Calculated - The Connection |
| | End Time minus the Connection |
| | Start Time. The Connection may |
| | have ended, but the Series |
| | may still be active. |
| Connection Port | Observed |
| Connection Protocol | Observed - May not correspond |
| | to the Connection Port |
| Connections per Series | Calculated - The number of |
| | Connections in the Series. |
| Connection Time per IP Address | Observed |
| Connection Duration per IP Address | Calculated |
| (inside) to IP Address (outside) | |
| Connection Protocol Sequence per IP | Calculated |
| Address (inside) to IP Address | |
| (outside) | |
| Connection Frequency per IP Address | Calculated - How frequently do |
| (inside) to IP Address (outside) | two IP addresses connect. |
| Series Start Time | Calculated - Same as the |
| | Connection Start Time |
| | of the first Connection |
| | in a Series. |
| Series Duration | Calculated - Current time minus |
| | Series Start Time. |
| Packet Length | Observed |
| Packet Length (average) Outgoing per | Calculated |
| Connections | |
| Packet Length (average) Incoming per | Calculated |
| Connections | |
| Packet Length (average) Outgoing per | Calculated |
| Series | |
| Packet Length (average) Incoming per | Calculated |
| Series | |
| Packet Length (average) Outgoing per | Calculated |
| IP Address | |
| Packet Length (average) Incoming per | Calculated |
| IP Address | |
| Packet Length (average) Outgoing - | Calculated |
| Total | |
| Packet Length (average) Incoming - | Calculated |
| Total | |
| Traffic Volume Outgoing per | Calculated - Based on observed |
| Connection | Packet Lengths |
| Traffic Volume Incoming per | Calculated - Based on observed |
| Connection | Packet Lengths |
| Traffic Volume Outgoing per Series | Calculated - Based on observed |
| | Packet Lengths |
| Traffic Volume Incoming per Series | Calculated - Based on observed |
| | Packet Lengths |
| Traffic Volume Outgoing per IP | Calculated - Based on observed |
| Address | Packet Lengths |
| Traffic Volume Incoming per IP | Calculated - Based on observed |
| Address | Packet Lengths |
| Traffic Volume Outgoing - Total | Calculated - Based on observed |
| | Packet Lengths |
| Traffic Volume Incoming - Total | Calculated - Based on observed |
| | Packet Lengths |
| LLC Length | Observed |
| LLC Length (average) Outgoing per | Calculated |
| Connections | |
| LLC Length (average) Incoming per | Calculated |
| Connections | |
| LLC Length (average) Outgoing per | Calculated |
| Series | |
| LLC Length (average) Incoming per | Calculated |
| Series | |
| LLC Length (average) Outgoing per IP | Calculated |
| Address | |
| LLC Length (average) Incoming per IP | Calculated |
| Address | |
| LLC Length (average) Outgoing - | Calculated |
| Total | |
| LLC Length (average) Incoming - | Calculated |
| Total | |
| Packet Data content | Observed |
| Packet Data content - % ASCII per | Calculated |
| Connection | |
| Packet Data content - % Binary per | Calculated |
| Connection | |
| Packet Data content - Histogram per | Calculated |
| Connection | |
| Packet Data content - % ASCII per | Calculated |
| Series | |
| Packet Data content - % Binary per | Calculated |
| Series | |
| Packet Data content - Histogram per | Calculated |
| Series | |
| Packet Data content - % ASCII per IP | Calculated |
| Address | |
| Packet Data content - % Binary per IP | Calculated |
| Address | |
| Packet Data content - Histogram per | Calculated |
| IP Address | |
| Packet Data content - % ASCII Total | Calculated |
| Packet Data content - % Binary Total | Calculated |
| Packet Data content - Histogram Total | Calculated |

The right column in Table I above describes whether each parameter's respective data value is observed by the sniffer or derived (i.e. calculated) based on one or more captured parameters.

Captured and derived data from the capture module 42 are then input to the logic engine 44 associated with the data analysis component to determine if a tunnel potentially exists through the firewall. This determination will be made by applying rules which are functionally based on associated captured and derived parameters. If the rule is evaluated to “True” (i.e., the rule is satisfied) then a tunnel is presumed to exist. Stated somewhat differently, whether or not each rule evaluates to “True” is indicative of adherence or non-adherence to network traffic norms.

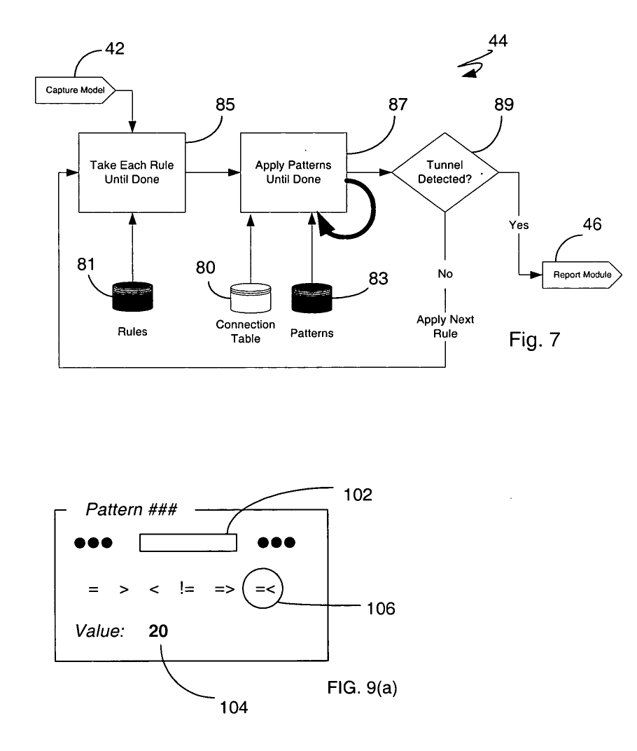

Logic engine 44 is illustrated in FIG. 7. Logic engine 44 receives detection data from capture module 42, wherein the detection data includes both the captured data and the derived data. Logic engine 44 utilizes a plurality of databases, namely a rules database 81 (referred to as RFILE), a patterns database 83 (referred to as PFILE), and data contained in connection table 80 (TFILE). Logic engine 44 recursively checks at 85 each appropriate rule from the rules database 81 to determine if a tunnel is detected. With respect to each such rule, the logic engine at 87 applies the pertinent patterns to the associated rule based on information from connection table 80 and the patterns database 83. For any rule which evaluates to “True” the conclusion is made at 89 that a potential tunnel has been detected, and logic engine 44 communicates this conclusion to the report module 46.

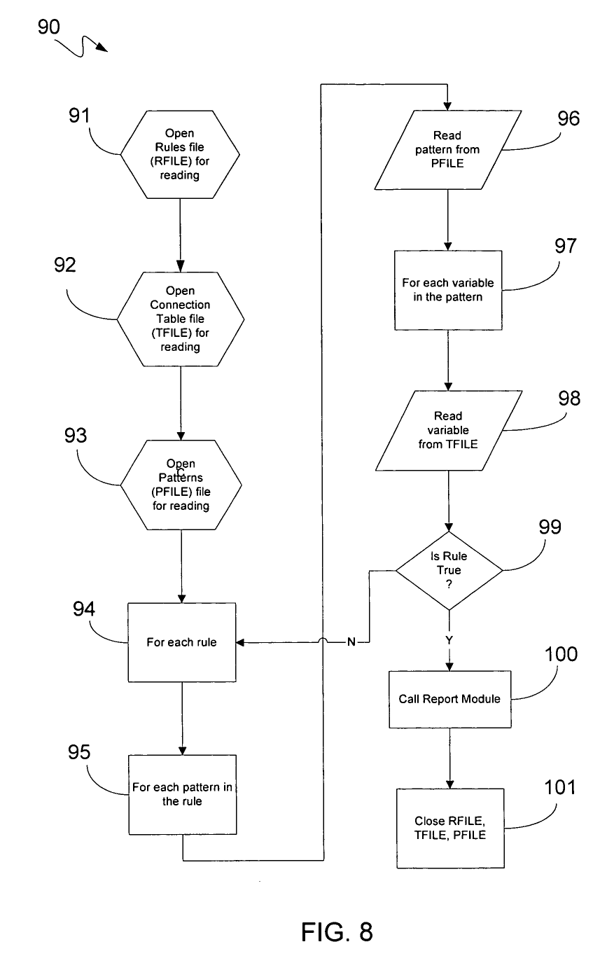

FIG. 8 represents a high level flowchart 90 for computer software which implements the functionality of the detector's logic engine 44. At 91, the rules file (RFILE) is opened for reading. The output file for the connection table (TFILE) is opened for reading at 92, as well as the patterns file (PFILE) at 93. For each rule at 94, and for each pattern in the respective rule at 95, the pattern file (PFILE) is read at 96. For each variable in the pattern file at 97, the corresponding variable from the output file (TFILE) is read at 98. An evaluation is then made at 99 as to whether the respective rule evaluates to true. If so, the report module is called at 100, and the various files are closed at 101. Otherwise, program flow returns to the next rule at 94 to continue the recursive checking until done.

Each rule consists of a set of patterns and Boolean operators. The following types of operators may be used in the rules.
∥ OR Operator—if one of the two patterns is “True”, then the operation evaluates to “True”
&& AND Operator—if both of the two patterns are “True”, then the operation evaluates to “True”
( ) Nesting Operator—the expression inside the parenthesis are evaluated first
   As a representative illustration, the following rule:
   Rule R45: (P23∥P53 ) && P221 && P2045
   can be interpreted as “Rule 45 consists of Pattern 23 OR Pattern 53 AND Pattern 221 AND Pattern 2045”, where “Pattern 23 OR Pattern 53” is evaluated first.

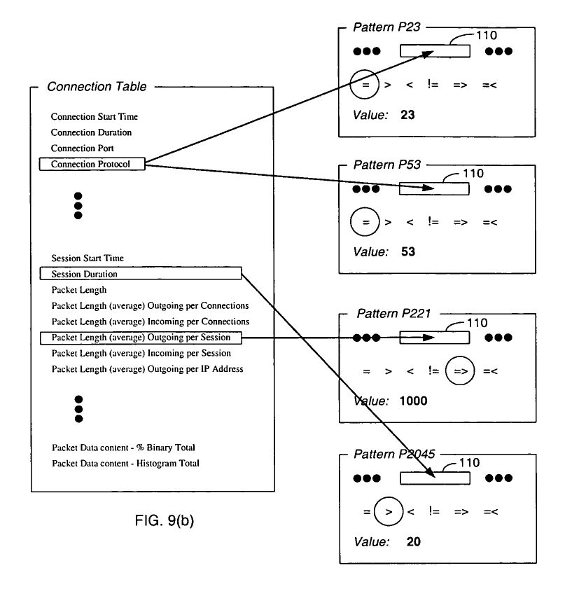

As shown in FIG. 9(a), each pattern preferably has three parts, two operands, 102 and 104 respectively, and an operator 106. Second operand 104 is a value that is compared with the first operand 102 based on the operator 106. Operator 106 can be any suitable operator, for example, selected from equal (=), greater_than (>), less_than (<), not_equal (!=), greater_than_or_equal (=>), and less_than_or_equal (=<). First operand 102 is an observed or derived parameter. As shown in FIG. 9(b), each first operand 102 maps as an entry in the connection table 80.

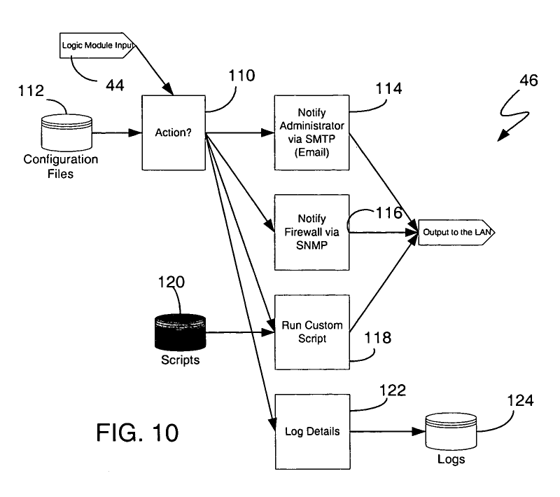

Once a tunnel is detected by logic engine 44, the connection information is passed to the report module 46 illustrated in FIG. 10. Report module 46 makes a determination at 110, based on user preferences as contained in configuration files 112, as to which responsive action should be taken. Any one or more of following actions can be taken:
Notify the Network Administrator at 114 via SMTP (email);
Notify the firewall at 116, via SNMP, to shutdown the session;
Run at 118 a pre-defined script from scripts database 120, with details of the connection being passed to the script; or
Log session details at 122 and create a logs database 124.

A network administrator, thus, has the flexibility to determine what responsive action(s) should be taken, such as contacting law enforcement. The action(s) can be handled by a script, such as a PERL script, at the shell level of the detector. The exact nature of the script will be dependent on the particular implementation desired.

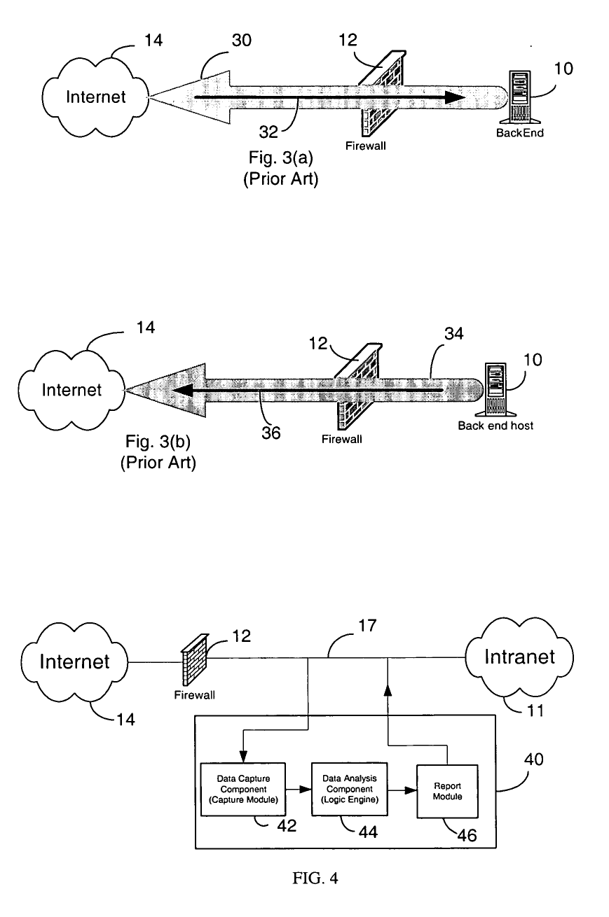

With the above discussion in mind, operation of the detector of the invention can be better appreciated from the following representative scenario. For purposes of the example, it is assumed that an employee has set up a tunnel through a corporate firewall, such as illustrated above in FIG. 3(b), and that the employee is using a Telnet session to mask other Internet activity. The masked activity is not known in this example, but is presumably activity that is not permitted such as non-work related web browsing. However, for the detector to operate, the nature of the masked activity need not be known. Furthermore, it need not be known how the tunnel was established, since detection is not restricted to existing tunneling capabilities. Thus, as hackers develop new and sophisticated means to establish tunnels, the detector will nonetheless remain viable and useful.

Pattern matching is used to analyze the captured and derived data (collectively, the detection data) to determine if a tunnel exists. For purposes of the example, returned packet sizes are used to determine that a tunnel exists via unauthorized activity conducted under the mask of the Telnet session. Four patterns can be checked against the connection table. A representative rule that uses these patterns is as follows:

Rule R45: (P23∥P53) && P221 && P2045

It should be understood that the reference numerals shown in the above statement and in the various tables herein which correspond to particular patterns and rules are for representative purposes only to illustrate that there may be numerous ones of interest. Simply stated, if pattern 23 or pattern 53 are true, and pattern 221 is true, and pattern 2045 is true, then rule 45 evaluates to “True” and a tunnel is presumed to exist. As shown in Table II below, pattern 23 checks to see if the employee is using telnet. Pattern 53 checks to see if the user is using a name server. Pattern 221 checks for the average size of an outgoing series packet size. Pattern 2045 checks for the time duration of the series. Thus, this representative rule 45 contemplates that if Telnet or name services are used for an extended duration, and the outgoing packets are large, then is presumed that a tunnel is being used.

TABLE II

| Rule/Pattern | Description | Application |
|---|---|---|
| R45 | Apply the Patterns | This rule takes either pattern P23 and P53 |
| | P23, P53, P221, | while also having patterns P221 and P2045 |
| | and P2045 | TRUE. |
| P23 | This Pattern is TRUE | If the port used is 23, Telnet is assumed to |
| | if the protocol used is | be the protocol. The bolded information, in |
| | Telnet. | the packet below, shows the protocol. |
| | | Flags: 0x00 |
| | | Status: 0x00 |
| | | Packet Length: 66 |
| | | Timestamp: 14:23:57.208727 09/02/2003 |
| | | Ethernet Header |
| | | Destination: 00:0A:F4:5F:20:B6 |
| | | Source: 00:05:5D:DA:99:AA |
| | | Protocol Type: 0x0800 IP |
| | | IP Header - Internet Protocol Datagram |
| | | Version: 4 |
| | | Header Length: 5 (20 bytes) |
| | | Type of Service: %00000000 |
| | | Precedence: Routine, Normal Delay, Normal |
| | | Throughput, Normal Reliability |
| | | Total Length: 48 |
| | | Identifier: 41728 |
| | | Fragmentation Flags: %010 Do Not Fragment Last |
| | | Fragment |
| | | Fragment Offset: 0 (0 bytes) |
| | | Time To Live: 128 |
| | | Protocol: 6 TCP |
| | | Header Checksum: 0xD46F |
| | | Source IP Address: 192.168.1.6 |
| | | Dest. IP Address: 192.168.1.1 |
| | | No IP Options |
| | | TCP - Transport Control Protocol |
| | | Source Port: 1029 |
| | | Destination Port: 23 TELNET |
| | | Sequence Number: 587855 |
| | | Ack Number: 0 |
| | | Offset: 7 |
| | | Reserved: %000000 |
| | | Code: %000010 |
| | | Synch Sequence |
| | | Window: 5840 |
| | | Checksum: 0xECE7 |
| | | Urgent Pointer: 0 |
| | | TCP Options: |
| | | Option Type: 2 Maximum Segment Size |
| | | Length: 4 |
| | | MSS: 1360 |
| | | Option Type: 1 No Operation |
| | | Option Type: 1 No Operation |
| | | Option Type: 4 |
| | | Length: 2 |
| | | Opt Value: |
| | | No More TELNET Data |
| | | Frame Check Sequence: 0x00000000 |
| P53 | This Pattern is | If the port used is 53, Domain Service is |
| | TRUE if the | assumed to be the protocol. The bolded |
| | protocol used is | information, in the packet below, shows the |
| | Domain Name | protocol. |
| | Service. | Flags: 0x00 |
| | | Status: 0x00 |
| | | Packet Length: 66 |
| | | <deleted lines> |
| | | TCP - Transport Control Protocol |
| | | Source Port: 1029 |
| | | Destination Port: 53 Domain Name Server |
| | | <deleted lines> |
| | | Frame Check Sequence: 0x00000000 |
| P221 | This Pattern is | The size of the packet is available from the |
| | TRUE if the | tcp dump. The size for each packet in a |
| | average size of the | connection is read and a running sum is |
| | outgoing packets | maintained. The sum divided by the number |
| | (for a given | of packets in the connection produces the |
| | connection) is | average packet size. The bolded |
| | greater than 1000. | information, in the packet below, shows the |
| | | packet size. |
| | | Flags: 0x00 |
| | | Status: 0x00 |
| | | Packet Length: 66 |
| | | <deleted lines> |
| | | Frame Check Sequence: 0x00000000 |
| P2045 | This Pattern is | The time stamp on the first packet of a new |
| | TRUE if the time | connection is stored in the connection table. |
| | duration for the | This time is then subtracted from the time |
| | connection is over | stamp on every subsequent packet in this |
| | 20 minutes. | connection. This yields the duration of |
| | | connection. The bolded information, in the |
| | | packet below, shows the time of the packet. |
| | | Flags: 0x00 |
| | | Status: 0x00 |
| | | Packet Length: 66 |
| | | Timestamp: 14:23:57.208727 09/02/2003 |
| | | <deleted lines> |
| | | Frame Check Sequence: 0x00000000 |

FIG. 9(b), discussed above, diagrammatically illustrates how the four patterns in Rule 45 have their first operand data mapped to the connection table. Table III below shows a subset of connection information which would be compiled by the detector, wherein only the entries which apply to the rules and patterns in this example are shown.

TABLE III

| Connection Table Item | Value | Description |
|---|---|---|
| Connection Protocol | 23 | The value of ‘23’ indicates |
| | | that the connection is a Telnet |
| | | session. This value will |
| | | cause Pattern P23 to be |
| | | TRUE. |
| Series Duration | 21 | The value of ‘21’ indicates |
| | | that the connection has been |
| | | established for 21 minutes. |
| | | This value will cause Pattern |
| | | P2045 to be TRUE. |
| Packet Length (average) | 1250 | The value of ‘23’ indicates |
| Outgoing per Series | | that the average packet size |
| | | has been 1250 bytes. This |
| | | value will cause Pattern P221 to be |
| | | TRUE. |

Based on the values in Table III, pattern 23 matches, pattern 221 matches, and pattern 2045 matches. Since either pattern 23 or pattern 53 is needed, the first part of rule 45 is satisfied. Since the first part and pattern 221 and pattern 2045 are all true, the entire rule evaluates to true. Therefore, a determination is made that a tunnel exists.

With the above in mind, the following provides a representative rules set and pattern set which may be employed to ascertain an existence of tunneling.:

IF a low data protocol uses many bytes, this may indicate a tunnel.
Rule R45: (P23∥P53 ) && P221 && P2045
Pattern P23: Packet Protocol==“telnet”
Pattern P53: Packet Protocol==“dns”
Pattern P221: TRUE if Series Duration>=21 minutes
Pattern P2045 : TRUE if Packet Length (average) Outgoing per Series>=1250

IF there is a sustained connection between two hosts, this may indicate a tunnel.
Rule R185: P98∥P99
Pattern P98: Connection Frequency IPin to IPout>=200
Pattern P99: True if Series Duration>=1200 seconds.

If any of the following key words are found in non-TCP packets, then a tunnel is suspected—HTTP, GET, POST, jpeg, and SMTP.
Rule R233: P12333∥P12334∥P12335∥P12336∥P12337
Pattern P12333: Packet Data contains “HTTP”
Pattern P12333: Packet Data contains “GET”
Pattern P12333: Packet Data contains “POST”
Pattern P12333: Packet Data contains “jpeg”
Pattern P12333: Packet Data contains “SMTP”

If encryption is found in ICMP or UDP packets, this may indicate a tunnel. Encryption is defined as fairly random data.
Rule R12: (P101∥P103) && P345
Pattern P101: Packet Type==“ICMP”
Pattern P103: Packet Type==“UDP”
Pattern P345: Packet Data Content—Histogram<=1.0

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

What is claimed is:

1. A computerized method for determining whether tunneling activity is occurring through a network firewall between two network devices which communicate through transmission of data packets, said computerized method comprising:
establishing a set of norms for network traffic through the firewall;
monitoring a series of the data packets transmitted through the firewall;
analyzing attributes associated with the data packets in order to determine one of:
an absence of tunneling activity if the attributes conform to the set of norms; and
an existence of tunneling activity if the attributes fail to conform to the set of norms.

2. A computerized method according to claim 1 whereby the set of norms includes one or more expectations selected from a group consisting of:
a first expectation that an average outbound packet length for selected communications protocols should not exceed a selected packet length value;
a second expectation that a series of connections between the two computer systems should not exceed a selected time duration value;
a third expectation that a frequency of connections between the two computer systems should not exceed a selected connection frequency value;
a fourth expectation that data corresponding to any of a plurality of key words should be absent in non-TCP packet transmission types; and
a fifth expectation that encrypted data should be absent in particular communications protocols.

3. A computerized method according to claim 2 whereby the selected communications protocols are telnet and dns, and whereby the selected packet length value is between about 1000 bytes and 1500 bytes.

4. A computerized method according to claim 3 whereby the selected communications protocols are telnet and dns, and whereby the selected packet length value is 1250 bytes.

5. A computerized method according to claim 2 whereby the selected time duration value is between about 10 minutes and 30 minutes.

6. A computerized method according to claim 2 whereby the plurality of key words are selected from a group consisting of: http, get, post, jpeg and smtp.

7. A computerized method according to claim 2 whereby said particular communications protocols include ICMP and UDP.

8. A computerized method according to claim 1 whereby monitoring of the data packets transmitted through the firewall is accomplished with a network sniffer.

9. A computerized method for ascertaining a potential existence of tunneling activity between a front end computer system located exteriorly of a network firewall and a back end computer system located behind the network firewall, wherein said front end and back end computer systems are adapted to communicate according to an overt communications protocol by transmitting network traffic through the firewall as a stream of data packets, said computerized method comprising:
establishing a set of parameters, each corresponding to a respective attribute of interest for network traffic transmitted through the firewall;
establishing a set of norms, each based on at least one of said parameters;
monitoring network traffic transmitted through the firewall;
collecting data corresponding to the set of parameters from each of a series of data packets associated with network traffic transmitted through the firewall, thereby to generate captured data;
generating detection data from the captured data;
analyzing the detection data to determine whether it adheres to the set of norms; and
identifying an existence of potential tunneling activity between the front end and back end computer systems upon a determination that the detection data fails to conform to any one of the set of norms.

10. A computerized method according to claim 9 whereby monitoring of the network traffic through the firewall is accomplished through a network sniffer.

11. A computerized method according to claim 10 whereby said network sniffer captures, with respect to each connection between the front end and back end computer systems, data corresponding to connection start time, connection end time, connection port, connection protocol, connection source IP address, connection destination IP address, and packet length.

12. A method according to claim 9 whereby the set of norms includes one or more expectations selected from a group consisting of:
a first expectation that an average outbound packet length for selected communications protocols should not exceed a selected packet length value;
a second expectation that a series of connections between the two computer systems should not exceed a selected time duration value;
a third expectation that a frequency of connections between the two computer systems should not exceed a selected connection frequency value;
a fourth expectation that data corresponding to any of a plurality of key words should be absent in non-TCP packet transmission types; and
a fifth expectation that encrypted data should be absent in particular communications protocols.

13. A detector adapted to be situated behind a network firewall for use in determining whether tunneling activity is occurring through the firewall, said detector comprising:
a data capture component for passively monitoring network traffic passing through the firewall and for producing detection data corresponding thereto; and
a data analysis component for comparing the detection data to a set of norms for network traffic that are characteristic of an absence of tunneling activity, and for identifying a potential existence of tunneling activity if the detection data fails to conform to any one of the set of norms.

14. A detector according to claim 13 comprising a response component for initiating at least one of a plurality of responses upon identifying a potential existence of tunneling activity.

15. A detector according to claim 14 wherein said plurality of responses is selected from a group consisting of:
a first response which entails transmission of a suitable notification to an administrator of the network;
a second response which entails transmission of a suitable notification to the firewall for the purpose of terminating the tunneling activity;
a third response which entails execution of a pre-defined script; and
a fourth response which entails creation a log containing data parameters for the tunneling activity.

16. A detector according to claim 13 wherein said detection data includes captured data from a network sniffer and derived data that is generated from said captured data.

17. A detector according to claim 13 wherein said data capture component stores said detection data as a connection table in memory which is accessible by said data analysis component.

18. A detector according to claim 13 wherein said data analysis component includes a logic engine for sequentially determining, with respect to each of said set of norms, whether said detection data conforms thereto.

19. A detector according to claim 13 wherein said set of norms includes one or more expectations selected from a group consisting of:
a first expectation that an average outbound packet length for selected communications protocols should not exceed a selected packet length value;
a second expectation that a series of connections between two computer systems should not exceed a selected time duration value;
a third expectation that a frequency of connections between two computer systems should not exceed a selected connection frequency value;
a fourth expectation that data corresponding to any of a plurality of key words should be absent in non-TCP packet transmission types; and
a fifth expectation that encrypted data should be absent in particular communications protocols.
